(19) United States
(12) Patent Application Publication
(10) Pub. No.: US 2026/0046909 A1
(43) Pub. Date: Feb. 12, 2026

(54) MANAGING MIGRATION INVOLVING A MOBILE INTEGRATED ACCESS AND BACKHAUL NODE

(71) Applicant: CANON KABUSHIKI KAISHA, Tokyo (JP)

(72) Inventors: Pierre VISA, RENNES (FR); Pascal LAGRANGE, La Chapelle des Fougeretz (FR)

(21) Appl. No.: 18/995,674

(22) PCT Filed: Jul. 18, 2023
(86) PCT No.: PCT/EP2023/069959

§ 371 Date: Jan. 16, 2025

(30) Foreign Application Priority Data
Jul. 21, 2022 (GB) 2210707.2

(51) Int. Cl. H04W 72/52; H04L 43/0876; H04W 36/36

(52) U.S. Cl. CPC H04W 72/52; H04L 43/0876; H04W 36/362

(57) ABSTRACT

There is provided a method for use in a process for requesting resources by a source Integrated Access and Backhaul (IAB) topology from a target IAB topology of a communication system, each of the source IAB topology and the target IAB topology comprising a set of IAB nodes and a donor Central Unit (CU), the method at the source donor-CU of the source IAB topology comprising: transmitting a message to the target donor-CU relating to the request of the resources associated with an IAB-node of the source IAB topology; wherein the message comprises an indication identifying the IAB-node of the source IAB topology as a mobile IAB-node. A corresponding method at the target donor, and devices are also disclosed.

### FIELD OF THE INVENTION

The present invention generally relates to methods for use in a process for migrating nodes and traffic between Integrated Access and Backhaul, IAB, topologies of a wireless communication system involving mobile IAB nodes.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . ) over a radio access network (RAN) through one or more base stations. The base stations are conventionally wired-connected (e.g., through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as Wi-Fi.

The demand for network densification increases due to the rising number of users and higher throughput requirement.

Facing the issues of high deployment costs and time of the wired backhaul networks with network densification, 3GPP has proposed, from release 16 for 5G NR, a wireless backhaul, also known as Integrated Access and Backhaul, IAB, where part of the wireless (i.e., radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate. However, millimeter waves are known to be subject to strong attenuations of signal strength in some weather conditions (rain, fog), and to blockage in case of obstacles located in the path between the emitter and the receiver.

To manage these potential radio link failures, a topological redundancy can be provided within the IAB framework, where multiple data paths are set up between the IAB base station directly connected to the core network (also referred to as the “IAB-donor”) and the IAB base station serving UEs (also referred to as the “access IAB-node” for the UEs). Several intermediate IAB base stations (also referred to as IAB-nodes) may be involved in each of the several paths between the IAB-donor and the access IAB-node, thus forming alternative data paths within a multi-hop IAB topology.

Besides, 3GPP has been considering inter-donor redundancy, where an IAB-node, referred to as a boundary IAB node, can access two different parent nodes connected to two different IAB-donors. The boundary IAB-node, even though belonging to a single IAB topology, i.e., belonging to a single IAB-donor for configuration and management, is thus able to route packets from a first IAB topology managed by a first IAB-donor to a second IAB network managed by a second IAB-donor. The advantage of such inter-donor redundancy lies in the ability for the first IAB-donor to perform offloading by routing some of its packets through the second IAB topology, thus mitigating congestion issues or overcoming radio link failure issues that may arise in the first IAB topology.

There are other situations rendering an IAB-node into a boundary node. This is the case of an IAB-node that experienced radio link failure and that has recovered through a parent IAB-node belonging to another IAB topology. This is also the case of migration of an IAB-node decided by the IAB-donor, where the IAB-node becomes connected to a single parent IAB-node belonging to another IAB topology controlled by another IAB-donor. The migrated IAB-node and its potential descendant IAB node(s) still belong to the initial IAB topology, and such migration is called partial migration. It should be followed by traffic migration where the traffic related to the boundary node and its descendant IAB-nodes is routed through the other IAB topology up to the boundary node (i.e., the migrated IAB-node).

Partial migration is suitable for stationary IAB-nodes. Indeed, a backhaul link (defined between two successive IAB-nodes in the wireless backhaul) may experience failure due to fluctuations of radio conditions and, for IAB-nodes that do not move, it should be a temporary situation with possible link recovery after some time. As such it is not required for such stationary IAB-nodes to perform a full migration toward a new IAB topology. Thus, the transmission and confirmation of many protocol messages can be avoided when migration is limited to partial migration.

Based upon the fixed IAB foundations of releases 16 and 17, 3GPP is now considering Mobile IAB systems and architecture, as a part of the release 18 framework, in order to address scenarios focusing on mobile IAB-nodes mounted on vehicles. In such scenarios, mobile IAB-nodes can be referred to as Vehicle Mounted Relays (VMR), providing 5G coverage/capacity to on-board and/or surrounding UEs.

The technical benefits of using vehicle relays include, among others, the ability of the relay vehicle to get better macro coverage than the nearby UE, thanks to better RF/antenna capabilities, thus providing the UE with a better link to the macro network. Additionally, a vehicle relay is expected to have less stringent power/battery constraints than the UEs.

Urban environments are usually characterised by a high density of users along with the presence of a significant number of vehicles (e.g., public/private passengers transportation, goods delivery, food trucks . . . ). Some of these vehicles (e.g., buses, trams, trains), may have predictable routes and a significant number of collocated UEs (i.e., passengers'devices).

For a mobile IAB-node it is worth performing the full migration from a first IAB topology to a second IAB topology, as the connection to a parent IAB-node belonging to the first IAB topology may not occur again as the mobile IAB-node is moving away. However, the full migration should be managed step by step to avoid service interruption, with partial node migration and traffic migration as the first steps. The full migration also involves the handover of UEs served by the migrating mobile IAB-node.

According to release 17 (TS 38.401 v17.0.0 section 8.7.3.1), when a source IAB-donor requests partial migration for an IAB-node, traffic migration, or UE handover, the target IAB-donor can reject the request, for instance because of load issue. However, in case of mobile IAB-node, such revocation should be avoided as the mobile IAB-node is moving and it may not have other connection option to continue serving UEs.

Therefore, some new mechanisms are required to overcome the aforementioned issue, i.e., to avoid the revocation of node/traffic migration, and the revocation of UE handover related to a mobile IAB-node.

### SUMMARY

The invention in general relates to signaling that a migration, dual connectivity or handover request involves a mobile base station or relay so that the request can be prioritized accordingly. This has particular relevance to a mobile communications network (e.g., 5G) utilizing mobile IAB-nodes. Other applications include other wireless communication networks such as Wi-Fi where a mobile base station, or relay, or access point may be utilized.

In the example of a mobile communications network such as 5G, the messages are exchanged between ‘IAB donors’ (specifically their central units) which connect the IAB-nodes which are wireless (i.e., connected via radio link rather than optical fibres) to the wired (e.g., fibre) backhaul and to the core network. Other wireless networks may have equivalent nodes and the invention may equally apply to these. As such, the term ‘IAB donor’ could be interchanged with ‘donor’

According to one aspect of the invention there is provided a method for use in a process for requesting resources from a source donor to a target donor of a communication system, each of the source donor and the target donor controlling a set of wireless nodes, the method at the source donor comprising: transmitting a message to the target donor relating to the request of resources associated with a wireless node; wherein the message comprises an indication identifying the wireless node is a mobile wireless node or not.

In such a way the transfer of resources associated with the mobile wireless mode may be prioritized (e.g., over static wireless nodes).

Advantageously, this is aspect is implemented in a NR environment such as 5G.

According to another aspect of the invention there is provided a method for use in a process for requesting resources by a source Integrated Access and Backhaul (IAB) topology from a target IAB topology of a communication system, each of the source IAB topology and the target IAB topology comprising a set of IAB nodes and a donor Central Unit (CU), the method at the source donor-CU of the source IAB topology comprising: transmitting a message to the target donor-CU of the target IAB topology relating to the request of resources associated with an IAB-node of the source IAB topology; wherein the message comprises an indication identifying the IAB-node as a mobile IAB-node.

Optionally, for efficiency of signaling, the indication identifying the IAB-node of the source IAB topology as a mobile IAB-node may comprise a Boolean.

Optionally, to assist a prioritization decision, the message may comprise information regarding the number of user equipment served by the mobile IAB-node.

Optionally, the message comprises a quality-of-service level. For example, the quality-of-service level indicates at least one quality-of-service parameter among: a priority level, a required packet delay budget, a required packet error rate, and a maximum data burst level.

To provide an accurate indication of requirements, the quality-of-service level may comprise a combination of several quality-of-service parameters.

Optionally, the process for requesting resources comprises an IAB Inter-CU topological redundancy procedure.

Optionally, the process for requesting resources comprises an IAB Inter-CU Backhaul radio link failure recovery.

Optionally, the process for requesting resources comprises a Reestablishment request procedure.

Optionally, the process for requesting resources comprises an inter-CU topology adaptation procedure.

Optionally, the process for requesting resources comprises a full migration of the IAB-node. This may be a common type of migration for mobile IABs on board busses or trains for example.

Optionally, the IAB-node includes a Distributed Unit (DU) part, and wherein the full migration consists in the migration of the DU part of the IAB-node from the source donor-CU to the target donor-CU.

Optionally, the process for requesting resources comprises a user equipment Handover (HO) procedure.

Optionally, the process for requesting resources comprises a user equipment Conditional Handover (CHO) procedure.

Optionally, the indication identifying the IAB-node as a mobile IAB-node comprises an indication that the UE undergoing handover is served by the mobile IAB-node.

Optionally, the method further comprises prior to the step of transmitting a message, determining that the IAB-node of the source IAB topology is a mobile IAB-node.

Optionally, determining that the IAB-node is a mobile IAB-node comprises obtaining a user equipment context.

Optionally, the method further comprises receiving a request for a user equipment context from the target donor-CU.

According to another aspect of the invention there is provided a method for use in a process for requesting resources by a source Integrated Access and Backhaul (IAB) topology from a target IAB topology of a communication system, each of the source IAB topology and the target IAB topology comprising a set of IAB nodes and a donor Central Unit (CU) the method at the target donor-CU of the target IAB topology comprising: receiving a message relating to the request of resources associated with an IAB node of the source IAB topology; obtaining from said message, an indication identifying that the related IAB-node of the source IAB topology is a mobile IAB-node or not; and determining whether to accept or reject the request in dependence on said indication.

In such a way, a request for resources involving a mobile IAB may be prioritized by the target donor.

Optionally, the method comprises prioritising the request in dependence on the indication.

Optionally, the method comprises always accepting the request in dependence on the indication.

Optionally, to manage load, determining whether to accept or reject the request is further in dependence on a current load of the target IAB topology.

Alternatively, or in addition, determining whether to accept or reject the request may be further in dependence on a current load on backhaul links in the target IAB topology.

Optionally, requesting resources relates to a request for a partial migration of the IAB-node of the source IAB topology.

Optionally, the IAB-node includes a Mobile Termination (MT) part, and wherein the partial migration comprises the migration of the MT part of the IAB-node from the source donor-CU to the target donor-CU.

Optionally, requesting resources relates to a request to establish a dual connectivity of the IAB-node with the source donor CU and the target donor CU.

According to other aspects of the invention there are provided a source donor device and a target donor device adapted to carry out the methods described herein.

According to one aspect of the invention there is provided a source donor Central Unit, CU, for managing a process for requesting resources by a source Integrated Access and Backhaul (IAB) topology from a target IAB topology of a communication system, the source donor-CU comprising: means for transmitting a message to a target donor CU of the target IAB topology relating to the request of resources associated with an IAB-node of the source IAB topology; wherein the message comprises an indication identifying the IAB-node of the source IAB topology as a mobile IAB-node.

According to one aspect of the invention there is provided a target donor Central Unit, CU, for managing a process for requesting resources from a source Integrated Access and Backhaul, IAB, topology to a target IAB topology of a communication system, the target donor CU comprising: means for receiving a message relating to the request of resources associated with an IAB node of the source IAB topology; means for obtaining from the message, an indication identifying that the IAB-node of the source IAB topology is a mobile IAB-node or not; and means for determining whether to accept or reject the request in dependence on the indication.

Optionally, the means for determining is configured to prioritise the request in dependence on the indication.

Optionally, the means for determining is configured to always accept the request in dependence on the indication.

Other aspects of the invention relate to a computer program comprising instructions which, when the program is executed by a computer, cause the computer to carry out the method described herein. This computer program may be embodied in a transitory or non-transitory a computer-readable medium.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram of a communication system in which the present invention may be implemented according to one or more exemplary embodiments;

FIGS. 2a and 2b schematically illustrate stacks of some protocol layers involved into IAB operations;

FIG. 3 is a schematic diagram illustrating the format of a BAP Protocol Data Unit (PDU) or packet;

FIG. 4 is a schematic diagram of an example IAB communication system (or IAB network system) in which embodiments and examples of embodiments of the present invention may be implemented;

FIG. 5 is a schematic diagram of another example IAB communication system (or IAB network system) in which embodiments and examples of embodiments of the present invention may be implemented;

FIG. 6 illustrates an example of IAB-node architecture enabling full migration from a source IAB topology to a target IAB topology;

FIG. 7 is a simplified flowchart of example steps to perform full migration of an IAB-node including the handover of UEs served by the migrating IAB-node.

FIG. 8 is a simplified flowchart of example steps to perform the partial migration of a mobile IAB-node according to one or more embodiments of the invention;

FIG. 9 is a simplified flowchart of example steps to perform the dual-connectivity of a mobile IAB-node;

FIG. 10 is a simplified flowchart of example steps to perform the Radio Link Failure (RLF) recovery of a mobile IAB-node;

FIG. 11 is a flowchart of an example procedure to perform traffic migration from a first IAB topology to a second IAB topology;

FIG. 12 is a simplified flowchart illustrating example steps to perform the handover of UEs served by a mobile IAB-node fully migrating from a source IAB topology to a target IAB topology;

FIG. 13 shows a schematic representation of a wireless communication;

FIG. 14a is a flowchart of an example method for managing at a source donor CU the indication that partial migration or dual-connectivity setup is related to a mobile IAB-node;

FIG. 14b is a flowchart of an example method for managing at a target donor CU the indication that partial migration or dual-connectivity setup is related to a mobile IAB-node;

FIG. 15a is a flowchart of an example method for managing at a source donor CU the indication that a Radio Link Failure (RLF) recovery is related to a mobile IAB-node;

FIG. 15b is a flowchart of an example method for managing at a target donor CU the indication that a Radio Link Failure (RLF) recovery is related to a mobile IAB-node;

FIG. 16a is a flowchart of an example method for managing at a source donor CU the indication that a traffic migration is related to a mobile IAB-node;

FIG. 16b illustrates is a flowchart of an example method for managing at a target donor CU the indication that a traffic migration is related to a mobile IAB-node;

FIG. 17a is a flowchart of for managing at a source donor CU the indication that a UE handover is associated to a mobile IAB-node;

FIG. 17b is a flowchart of for managing at a target donor CU the indication that a UE handover is associated to a mobile IAB-node.

### DETAILED DESCRIPTION

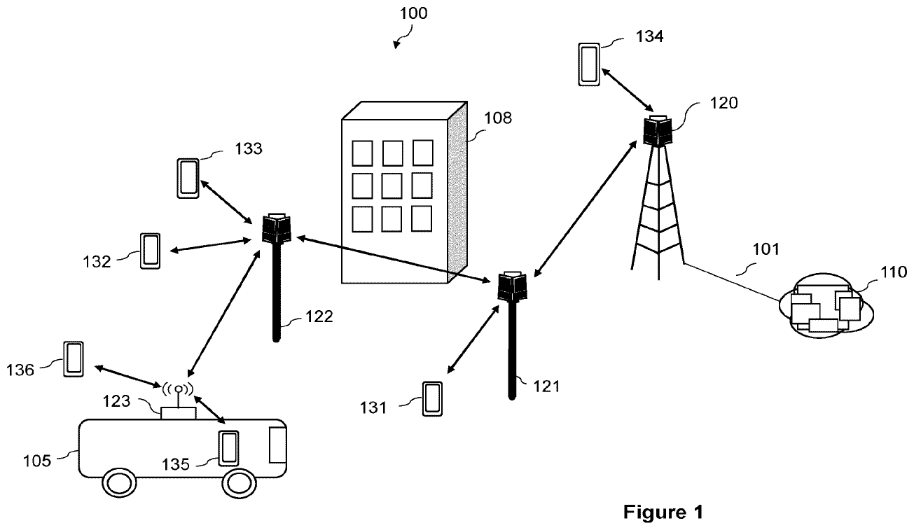

FIG. 1 illustrates an example wireless communication system 100, in particular a mobile radio communication system such as a fifth-generation (5G) New Radio (NR) system including a wireless Integrated Access and Backhaul network supporting mobile IAB-node. Although in the following description, embodiments and examples of embodiments of the present invention will be described with respect to a 5G NR system, it will be appreciated that it is not intended that the present invention is limited to 5G NR systems and may be used in any wireless communication systems having a mobile base station. In particular, the following description predominantly uses terminology specific to 5G, but it should be appreciated that such terminology also applies to elements or processes performing an equivalent function in other communication systems

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes), and a mobile Integrated Access and Backhaul (IAB) station 123 mounted on a vehicle 105 (for example, a bus, a train, a taxi, a car, etc.).

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v17.0.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The mobile IAB station 123, also referred to as mobile IAB-node 123 or mIAB node 123, is an IAB-node that is mounted on vehicle 105, also provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121 and 122 are thus forming a backhaul network or IAB network, or IAB topology, which accommodates UEs 132, 133, 131, 134, 135 and 136. The terms IAB network and IAB topology will be used interchangeably in the following.

The specification of the Integrated Access and Backhaul (IAB) is spread over several 3GPP standard documents, including:
TS 38.300 RAN architecture (V17.0.0),
TS 38.321 MAC protocol (V17.0.0),
TS 38.331 Radio Resource Control (RRC) protocol (V17.0.0),
TS 38.340 Backhaul Adaptation Protocol Layer (V17.0.0),
TS 38.401 RAN architecture (V17.0.0),
TS 38.473 F1 Application Protocol (V17.0.0).

As IAB-donor 120 and IAB-nodes 121, 122 and 123 are respectively connected to UEs 134, 131, 132, 133, 135 and 136, they are considered as Access IAB-nodes for their respectively connected UEs.

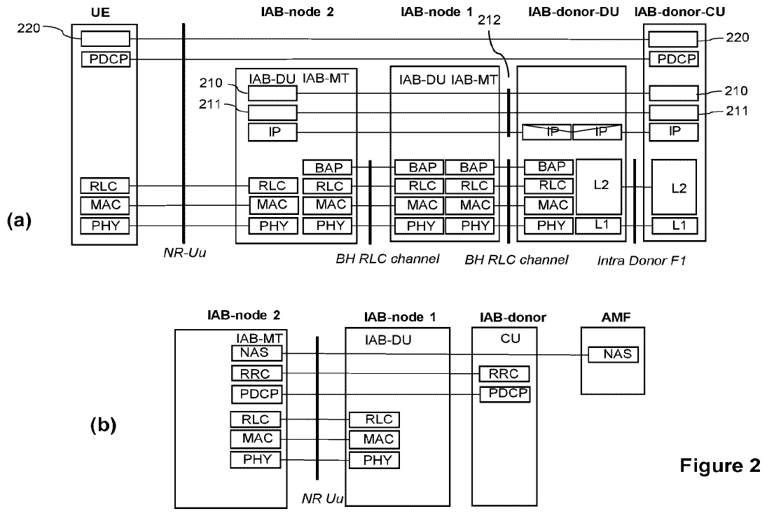

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU) includes lower layer protocols, such as the RLC, MAC and physical layer protocols. The IAB-donor CU or donor CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over intermediate IAB nodes. They form a directed acyclic graph (DAG) topology with the IAB-donor at its root.

The IAB nodes consist of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 performs centralized resource, topology and route management for the whole IAB topology. This includes configuring the IAB-nodes according to the network topology, e.g., in order to perform appropriate routing of data packets.

FIGS. 2a and 2b schematically illustrate stacks of some protocol layers involved in IAB operations.

F1 interface supports the exchange of signaling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g., of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node 1 and then from IAB-node 1 to IAB-node 2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signaling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS 38.473 and TS 38.401) provides signaling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

On the BAP sublayer, packets are routed based on the BAP routing ID, which is carried in the BAP header of the BAP packets, and which is set by the BAP sublayer of the emitting IAB-donor-DU or initiator IAB-node (e.g., a network node in the IAB network generating the BAP packets).

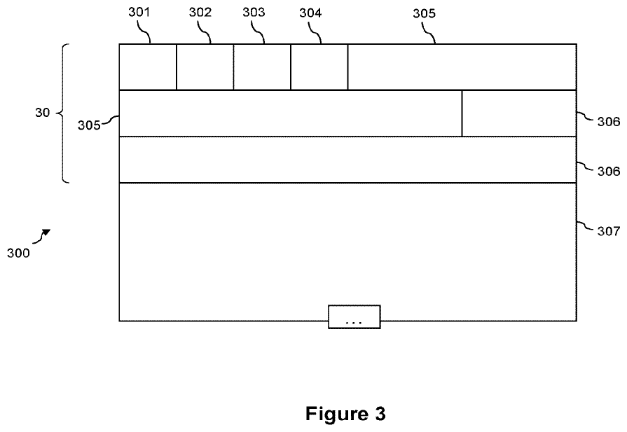

FIG. 3 illustrates the format of a BAP Data Protocol Data Unit (PDU) or packet. It is specified in the standardized version paragraph 6.2 of 3GPP TS 38.340 release 17.0.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e., on the BAP sublayer) of the destination IAB-node or IAB-donor DU for the BAP packet. For the purpose of routing, each IAB-node and IAB-donor DU in an IAB network is configured (by IAB-donor CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e., either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS 38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS 38.324. On the UE side, the SDAP sublayer exchanges the payload data with the user's application (voice, video, etc.—not shown in the Figure). On the IAB-donor CU side, the SDAP sublayer exchanges the data with the Core Network 110 (Internet traffic, Cloud, etc . . . ).

RRC sublayer 220 for the Control Plane handles the configuration of the protocol entities of the User Plane protocol stack. It is described in TS 38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e., its access IAB-node (for both CP and UP).

FIG. 2b comes from 3GPP TS 38.300 v17.0.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signaling Radio Bearers SRBs (bearers carrying RRC and NAS messages) with the IAB-donor-CU. These SRBs are transported between the IAB-MT and its parent node(s) over NR-Uu interface(s).

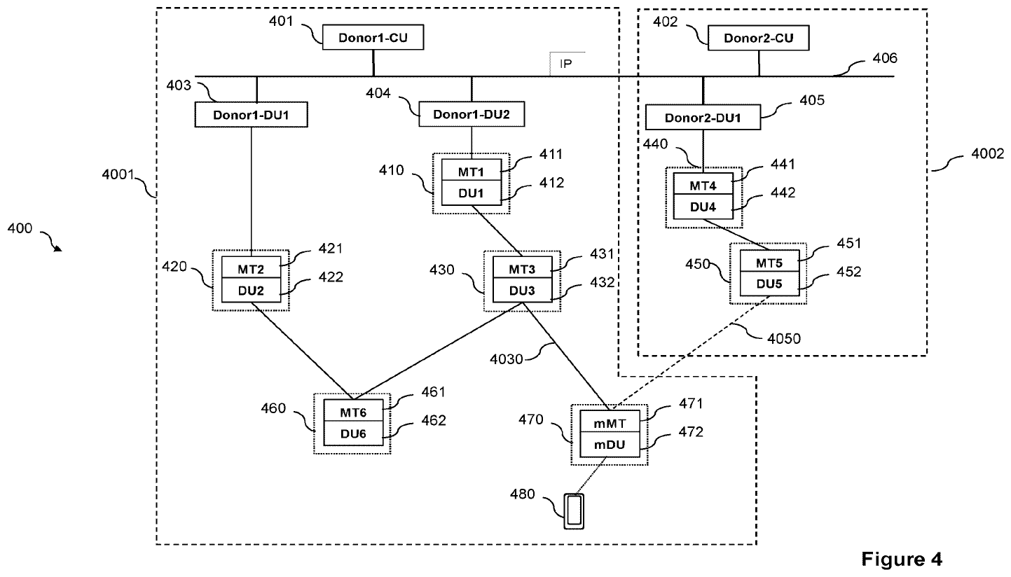

FIG. 4 illustrates an example of an IAB communication system (or IAB network system) 400 in which embodiments and examples of embodiments of the present invention may be implemented. In one example implementation, the BH radio links are operated over the millimeter wave frequency band (i.e., above 30 GHz), which is highly sensitive to radio channel disturbance. An IAB network will also be referred to as an IAB topology or topology and so in this application, the terms IAB network and IAB topology and topology will be used interchangeably.

IAB communication system 400 is composed of two IAB networks or IAB topologies 4001 and 4002 with each IAB topology comprising a set of IAB nodes (e.g., the set may comprise a plurality of IAB nodes or at least one IAB node) and an IAB-donor CU for controlling or managing the plurality of IAB nodes. The set of IAB nodes may include one or more IAB-nodes, such as initiator IAB-nodes which generate BAP packets and also intermediate or relay IAB-nodes. Each of the IAB nodes communicate with at least one other IAB node over a wireless backhaul (BH) link. Although FIG. 4 shows two IAB topologies 4001 and 4002, the present invention is not limited to two IAB topologies 4001 and 4002 and may be implemented in an IAB communication system comprising more than two IAB topologies with each topology comprising a set of IAB nodes and a IAB donor CU as discussed above.

IAB topology 4001 includes IAB-donor-CU 401 (identified as Donor 1-CU in FIG. 4), its associated IAB-donor-DUs, IAB-donor-DU 403 (identified as Donor 1 DU1 in FIG. 4) and IAB-donor-DU 404 (identified as Donor 1-DU2 in FIG. 4), and a plurality of IAB-nodes 410, 420, 430, and 460, similar to IAB-nodes 121 and 122, and IAB-node 470, similar to mobile IAB-node 123. All IAB-nodes can be access nodes serving UEs like the UE 480 served by the mobile IAB-node 470. The IAB topology 4001 is transparent for the UE 480 that connects to the donor CU 401 through the DU part or unit mDU 472 of the mobile IAB-node 470.

IAB topology 4002 includes IAB-donor-CU 402 (identified as Donor 2-CU in FIG. 4), and its associated IAB-donor-DU 405 (identified as Donor 2-DU1 in FIG. 4), and a plurality of IAB-nodes 440 and 450, similar to IAB-nodes 121 and 122.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 410 comprises a MT part or unit 411 and a DU part 412.

A wired backhaul IP network interconnects the IAB-donor-CUs 401 and 402, and the IAB-donor-DUs 403, 404 and 405 through wired link 406. For instance, this wired link consists of optical fiber cable(s).

IAB-Donor-CU 401, IAB-Donor-DU 403 and 404, IAB-nodes 410, 420, 430, 460, 470 and IAB-node 470 are part of the same IAB network or IAB topology 4001, which is configured and managed or controlled by IAB-Donor-CU 401.

IAB-Donor-CU 402, IAB-Donor-DU 405, and IAB-nodes 440 and 450 are part of the same IAB network or IAB topology 4002, which is configured and managed or controlled by IAB-Donor-CU 402.

Although IAB-node 470 belongs to IAB network 4001 (with IAB-node 430 as a parent through the BH link 4030), in view of its proximity to IAB network 4002 and in particular to IAB-node 450, IAB-node 470 may connect to IAB-node 450 (which would act as a parent node to IAB-node 470) through wireless BH link 4050. Such connection to IAB-node 450 in addition or in place of the connection to IAB-node 430 is possible for a stationary IAB-node, and it is very likely to happen for a mobile IAB-node like IAB-node 470, moving, for instance, in the direction of the IAB topology 4002.

Several scenarios are possible according to the IAB framework release 17.

As a first scenario, the topology redundancy procedure may be applied, as described in TS 38.401 v17.0.0 section 8.17.2.1, where a dual connectivity is established for the IAB-node 470 with two parent IAB-nodes 430 and 450 belonging to two different IAB topologies.

When the IAB-node 470 is initially connected to a single IAB topology (e.g., IAB topology 4001), the MT part or unit mMT 471 of IAB-node 470 periodically performs a cell search procedure, as defined in 3GPP TS 38.300, trying to detect PSS (Primary Synchronization Signal) and SSS (Secondary Synchronization Signal). The IAB-node may report to its donor CU 401 the presence of a new cell managed, for instance one cell managed by the IAB-node 450, through a measurement report. Based on the analysis of the measurement report, the donor CU 401 may request to the donor CU 402 the establishment of a dual connectivity for the IAB-node 470 with an additional connection through the IAB-node 450. The donor CU 402 may accept the request and proceed to the connection of the IAB-node 470 according to the procedure described in TS 37.340 v17.0.0 section 10.2. As a result, the IAB-node 470, still belonging to IAB topology 4001, is now also connected to IAB-node 450, which belongs to IAB topology 4002, and it may be referred to as a boundary node between IAB topology 4001 and IAB topology 4002. Actually, the IAB-node 470 retains its F1 connection and its RRC connection to the donor CU 401, which can be referred to as the F1-terminating IAB-donor-CU, and it has another RRC connection to the donor CU 402, which can be referred to as the non-F1-terminating IAB-donor-CU.

As the IAB-node or boundary node 470 is part of the IAB topology 4001 (from the F1 connection point of view), it is controlled (e.g., configured and managed) by the IAB-Donor-CU 401 of IAB topology 4001. Through the second RRC connection, the donor CU 402, assigns a second BAP address to be used for routing packets through the IAB topology 4002.

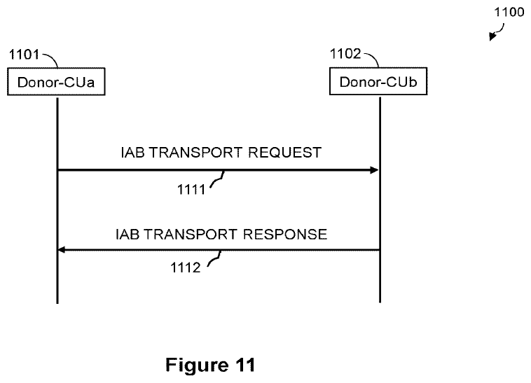

Indeed, the IAB-donor CU 401 may take benefit of the dual connectivity of IAB-node 470 between IAB topology 4001 and IAB topology 4002, to balance the traffic load in IAB topology 4001 by offloading, or migrating, some traffic (data/user traffic or control traffic) initially planned to be routed through IAB nodes 410, 430, and the BH link 4030. In this case and as described in TS 38.401 v17.0.0 section 8.17.2.1, the donor CU 401 triggers the IAB transport migration management procedure specified in TS 38.423 v17.0.0 section 8.5.2, with the exchange of protocol messages illustrated with the FIG. 11. The donor CU 402 may reject the request for a part or for the full traffic to be migrated, for instance because of load issue in the IAB topology 4002.

As a second scenario in the FIG. 4, the BH link or BH radio link 4030 may also experience radio link deficiency due to some unexpected interference or shadowing phenomena. For such reasons, the IAB-node 470 may lose the connection with the IAB-node 430 and declare a Radio Link Failure (RLF) for the BH link 4030. Then, the IAB-node 470 will try to re-establish the connection with the same or a different parent IAB-node (or donor-DU). Thus, the IAB-node 470 may try to join the IAB topology 4002 managed by IAB-donor CU 402 with a connection through the new parent IAB-node 450 through the BH link 4050. In this case, the inter-CU backhaul RLF recovery procedure may be applied, as described in TS 38.401 v17.0.0 section 8.17.4, which enables recovery of an IAB-node to another parent node underneath a different IAB-donor-CU, when the IAB-MT of the IAB-node declares a backhaul RLF. In such procedure, the donor CU 402 sends to the donor CU 401 a request to retrieve the context of the IAB-node 470. Based on the response from the donor CU 401, the donor CU 402 may accept the connection of the IAB-node 470, which becomes a boundary still belonging to the IAB topology 4001. Actually, the IAB-node 470 retains its F1 connection to the donor CU1 which can be referred to as the F1-terminating IAB-donor-CU, and it has a RRC connection to the donor CU 402, which can be referred to as the non-F1-terminating IAB-donor-CU.

Then, the IAB-donor CU 401 may request the migration toward the IAB topology 4002 of the traffic related to the IAB-node 470. In this case, the donor CU 401 triggers the IAB transport migration management procedure specified in TS 38.423 v17.0.0 section 8.5.2, with the exchange of protocol messages illustrated with the FIG. 11. The donor CU2 may reject the request for a part or for the full traffic to be migrated, for instance because of load issue in the IAB topology 4002. As a third scenario in the FIG. 4, the IAB-node 470 is single connected to the parent IAB-node 430 and may be partially migrated toward the IAB topology 4002, meaning its RRC connection is migrated from an old parent node to a new parent node, where the old and the new parent nodes are served by different IAB-donor-CUs. Indeed, based on the measurement report provided by the IAB-node 470, the donor CU 401 may detect that the IAB-node 470 would have a better connection through a cell managed by the IAB-node 450 belonging to the IAB topology 4002. Then, the donor CU 401 may trigger the IAB Inter-CU Topology Adaptation procedure described in TS 38.401 v17.0.0 section 8.17.3.1. In this procedure, the donor CU 401 sends a handover request for the IAB-node 470 along with information for the donor CU 402 to establish a RRC connection to the IAB-node 470. Based on this information, the donor CU 402 may accept the handover request and proceed to the admission of the IAB-node 470, which becomes a boundary node still belonging to the IAB topology 4001, with F1 connection to the donor CU 401 and RRC connection to the donor CU2.

Then, the IAB-donor CU 401 may request the migration toward the IAB topology 4002 of the backhaul traffic related to the IAB-node 470. In this case, the donor CU 401 also triggers the IAB transport migration management procedure specified in TS 38.423 v17.0.0 section 8.5.2, with the exchange of protocol messages illustrated with the FIG. 11. The donor CU2 may reject the request for a part or for the full traffic to be migrated, for instance because of load issue in the IAB topology 4002.

In case the IAB-node 470 has some child IAB-node(s), a similar procedure applies, as specified in TS 38.401 v17.0.0 section 8.17.3.2, where the donor CU 401 additionally configures the migrating node and the child IAB-node(s) to correctly route the BAP packets.

In this scenario, the IAB topology 4001 may be referred to as the source IAB network or source IAB topology, and the topology 4002 will be referred to as the target IAB network or target IAB topology. Also, the donor CU 401 may be referred to as the source IAB-Donor-CU or source donor CU, and the donor CU 402 will be referred to as the target IAB-Donor-CU or target donor CU.

In all the three scenarios described above, the UE 480 still connects to the donor-CU 401 through the DU part or unit mDU 472 of the mobile IAB-node 470. In case the IAB-node 470 has some child IAB-node(s), such child IAB-node still belongs to the IAB topology 4001, and it is still fully controlled (through F1 and RRC connections) by the donor CU 401.

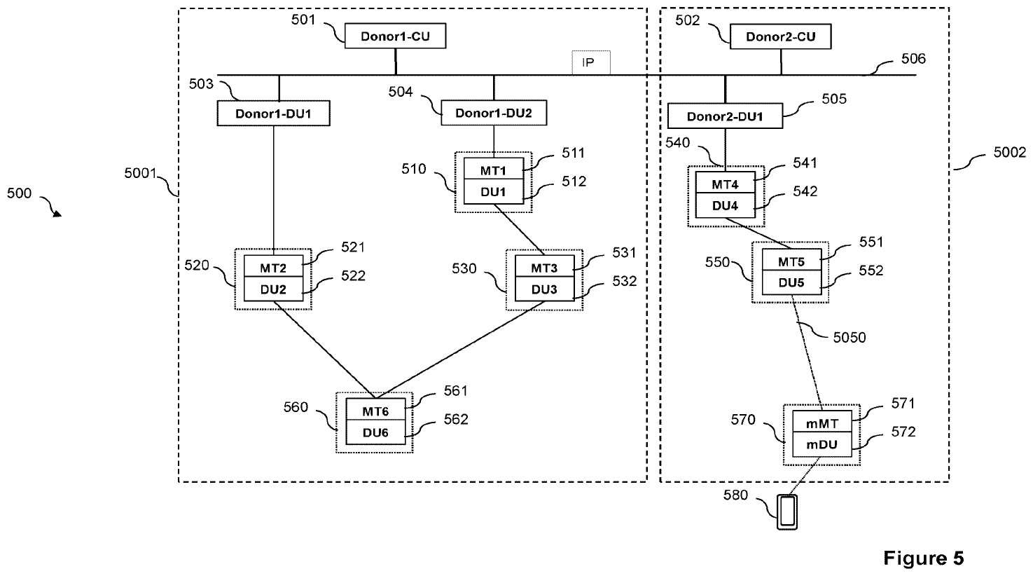

FIG. 5 illustrates another example of an IAB communication system (or IAB network system) 500 in which embodiments and examples of embodiments of the present invention may be implemented. It is similar to the system 400 described in the FIG. 4 with two IAB topologies 5001 and 5002. IAB topology 5001 includes IAB-donor-CU 501 (identified as Donor 1-CU in FIG. 5), its associated IAB-donor-DUs, IAB-donor-DU 503 (identified as Donor 1-DU1 in FIG. 5) and IAB-donor-DU 504 (identified as Donor 1-DU2 in FIG. 5), and a plurality of IAB-nodes 510, 520, 530, and 560, similar to IAB-nodes 121 and 122. IAB topology 5002 includes IAB-donor-CU 502 (identified as Donor 2-CU in FIG. 5), and its associated IAB-donor-DU 505 (identified as Donor 2-DU1 in FIG. 5), and a plurality of IAB-nodes 540 and 550, similar to IAB-nodes 121 and 122, and IAB-node 570, similar to mobile IAB-node 123. The IAB topology 5002 is transparent for the UE 580 that connects to the donor CU 402 through the DU part or unit mDU 572 of the mobile IAB-node 570.

Actually, FIG. 5 illustrates the result of the full migration of the IAB node 470 in FIG. 4 (i.e., the IAB-node 570 in FIG. 5), which now fully belongs to the IAB topology 4002 in FIG. 4 (i.e., the IAB topology 5002 in FIG. 5).

Partial migration (described in FIG. 4) allows for the IAB-MT part or unit mMT (471 in FIG. 4) to be migrated quickly to the target IAB-donor-CU (i.e., donor CU 402 in FIG. 4) and to be switched back quickly to the source IAB-donor-CU (i.e., donor CU 401 in FIG. 4). Thus, partial migration can be used advantageously when circumstances requiring inter-donor migration are only temporary, such as during traffic peak hours, or when transient RLF on a BH link is detected.

In the context of a full migration, both the IAB-MT part or unit mMT 571 and the IAB-DU part or unit mDU 572 of IAB-node 570 are migrated to the target donor CU 502. The full migration is appropriate for a mobile IAB-node that moves and may cross several IAB topologies along its journey.

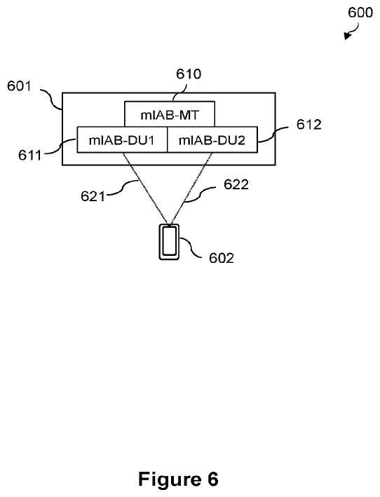

At the full migration of the IAB-node 570, the served UEs, like UE 580, also migrate from the source donor CU 401 to the target donor CU 402. UEs migration may be performed through a procedure, described with the FIGS. 6, 7 and 12, which is based on the handover procedure described in TS 38.300 v17.0.0 section 9.2.3.2.

FIG. 6 illustrates an example of IAB-node architecture 600 enabling the full migration from a source IAB topology to a target IAB topology along with a smooth UE handover. The mobile IAB node 601 like the IAB-node 570, is composed of an IAB-MT part or unit mIAB-MT 610, an IAB-DU1 part or unit mIAB-DU1 611, and an IAB-DU2 part or unit mIAB-DU2 612. mIAB-DU1 and mIAB-DU2 are two logical DU entities that share the same hardware for the BAP, RLC, and MAC layers. In one embodiment, they share the same physical layer (i.e., the same hardware resources), while in another embodiment they rely on separated physical layers. During the full migration phase, both logical DUs are active, one of the logical DU terminates the F1 interface with the source donor CU, while the other logical DU terminates the F1 interface with the target donor CU. Otherwise, only one logical DU is sufficient for IAB operations.

Before the full migration a UE 602 is for instance connected to a source donor CU through the logical DU mIAB-DU1 611 with the access link 621, while the logical DU mIAB-DU2 612 is deactivated. At the full migration, the logical DU mIAB-DU2 612 is activated and connects to a target donor CU, on which the UE 602 may also connect to through the logical DU mIAB-DU2 612 with the link 622. The activation may be triggered by the source donor CU with the message GNB-CU CONFIGURATION UPDATE, specified in TS 38.473 v17.0.0, including an information element for the list of cell(s) to be activated. Once the handover of UE 602 is completed from a cell controlled by the logical DU mIAB-DU1 611 to a cell controlled logical DU mIAB-DU2 612, the logical DU mIAB-DU1 611 may be deactivated. The deactivation may be triggered by the source donor CU 703 with the message F1 REMOVAL REQUEST specified in TS 38.473 v17.0.0, after the detection of the completion UEs handover.

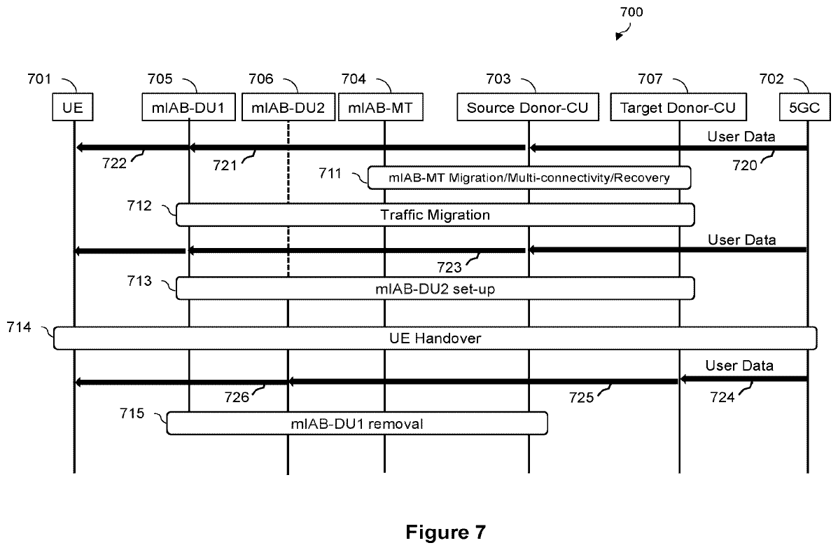

FIG. 7 is a simplified flowchart 700 illustrating an example of steps to perform the full migration of an IAB-node including the handover of UEs served by the migrating IAB-node.

This figure shows a UE 701 like the UE 580, a source donor CU 703 like the donor CU 501, a target donor CU 707 like the donor CU 502, the core network (5GC) 702 like the core network 110. This figure also shows a mobile IAB-node like the IAB-node 570 and 601 composed of an IAB-MT part or unit mIAB-MT 704, an IAB-DU1 part or unit mIAB-DU1 705, and an IAB-DU2 part or unit mIAB-DU2 706. mIAB-DU1 and mIAB-DU2 are two logical DU entities that share the same hardware for the BAP, RLC, and MAC layers. In one embodiment, they share the same physical layer (i.e., the same hardware resources), while in another embodiment they rely on separated physical layers.

At the beginning of the flowchart, the mobile IAB-node fully belongs to the source IAB topology controlled by the source donor CU 703. The UE 701 is served by the mobile IAB-node through a cell controlled by the mIAB-DU1 705, while the logical mIAB-DU2 706 is inactive. The user data in the downstream direction are provided by the 5GC 702 to the source donor CU 703 through the bearer 720, then they are transmitted to the logical DU mIAB-DU1 705 of the mobile IAB-node through the backhaul bearer 721 in the source IAB topology, and finally to the UE 601 through the data radio bearer 722. User data in the upstream direction (not represented in the figure) are transmitted through similar bearers in the opposite direction.

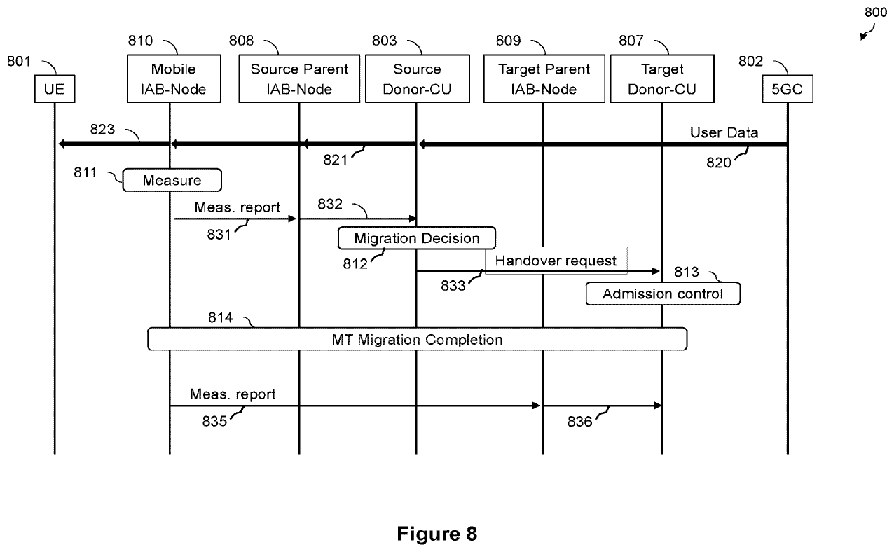

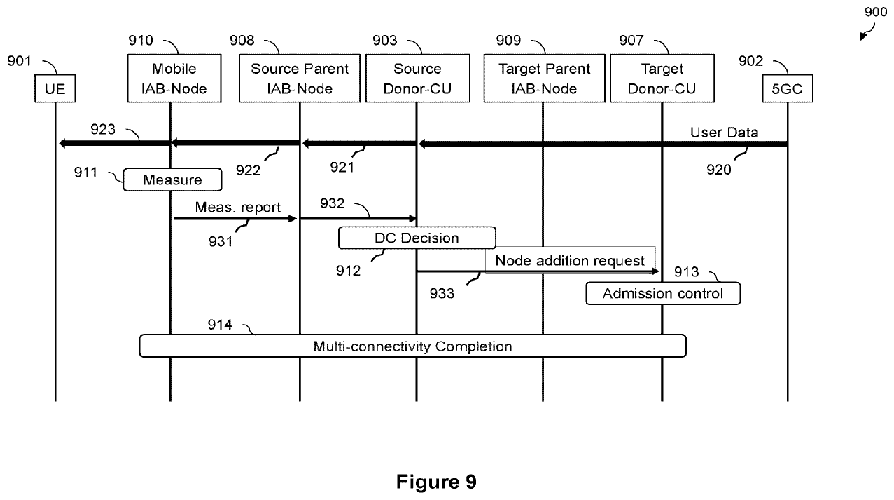

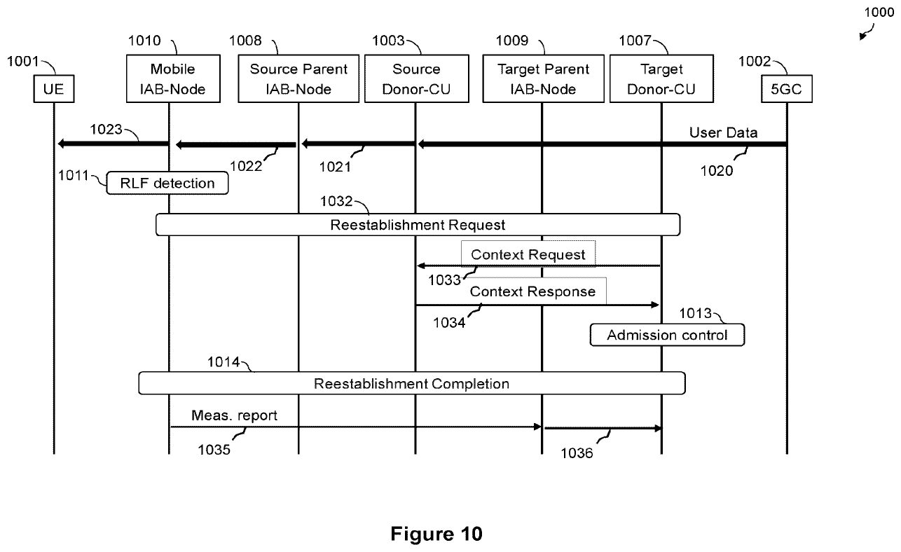

The first step 711 corresponds either to the partial migration of the IAB-node described with the FIG. 8, to the establishment of dual connectivity of the mobile IAB-node described with the FIG. 9, or to the RLF recovery of the mobile IAB-node described with the FIG. 10. After this step the mobile IAB-node is a boundary node between the source IAB topology controlled by IAB donor CU 703 and the target IAB topology controlled by the target donor CU 707.

The second step 712 corresponds to the traffic migration relying on protocol messages described in the FIG. 11. After this step, the user data in the downstream direction are still delivered to the UE 701 through the mIAB-DU1 705, but through the backhaul bearer 723 in the target IAB topology. User data in the upstream direction (not represented in the figure) are transmitted through similar bearers in the opposite direction.

The step 713 corresponds to the activation of the second logical DU mIAB-DU2 706 in the mobile IAB node. This step can be triggered immediately after the completion of the traffic migration step 712, or when a RLF is detected on the link between the mobile IAB-node and its parent IAB node in the source IAB topology.

After activation of the second logical DU in the mobile IAB node (step 713), the next step 714 consists in the handover of UEs served by the mobile IAB node, from a cell controlled by the first logical DU mIAB-DU1 705 to a cell controlled by the second logical DU mIAB-DU2 706 (or by a DU part of another base station in the vicinity). This step is described with details in the FIG. 11.

Once the handover of all UEs served by the mobile IAB-node is completed, the user data in the downstream direction are transmitted by the core network 702 to the target donor CU 707 through the bearer 724, then they are transmitted to the logical DU mIAB-DU2 706 of the mobile IAB-node through the backhaul bearer 725 in the target IAB topology, and finally to the UE 601 through the data radio bearer 726. User data in the upstream direction (not represented in the figure) are transmitted through similar bearers in the opposite direction.

In case of the mobile IAB-node 470 has some child IAB-node(s), the procedures described above for dual-connectivity, partial migration, RLF recovery may be applied for these child IAB-nodes.

The full migration procedure ends with the removal of the logical DU mIAB-DU1 705 of the mobile IAB-node.

The objective of the invention is to provide the necessary information to the target donor CU 707 to avoid the revocation by the target donor CU 707 of the admission of the mobile IAB-node in each scenario (multi-connectivity, partial/full migration, RLF recovery), and to avoid the revocation of the associated traffic migration. Another objective of the invention is to provide the necessary information to the target donor CU 707 to avoid the revocation of the handover of UEs served by the mobile IAN-node.

FIG. 8 is a simplified flowchart 800 illustrating an example of steps to perform the partial migration of a mobile IAB-node according to embodiments of the invention. This figure shows a UE 801 like the UE 480, a source donor CU 803 like the donor CU 401, a target donor CU 807 like the donor CU 402, the core network (5GC) 802 like the core network 110. This figure also shows a mobile IAB-node 810 like the IAB-node 470, a source parent IAB-node 808, like the IAB-node 430, belonging to the IAB topology controlled by the source donor CU 803, a target parent IAB-node 809, like the IAB-node 450, belonging to the IAB topology controlled by the target donor CU 807.

At the beginning of the flowchart, the mobile IAB-node 810 fully belongs to the source IAB topology controlled by the source donor CU 803. It is connected through a cell controlled by the source parent IAB-node 808. The UE 801 is served by the mobile IAB-node 810. The user data in the downstream direction are provided by the 5GC 802 to the source donor CU 803 through the bearer 820, then they are transmitted to the mobile IAB-node 810 via the source parent IAB-node 808 through the backhaul bearer 821 in the source IAB topology, and finally to the UE 801 through the data radio bearer 823. User data in the upstream direction (not represented in the figure) are transmitted through similar bearers in the opposite direction.

The source donor CU 803 has the information that the IAB-node 810 is a mobile IAB-node, for instance, because it was informed at the RRC connection of the IAB-node 810, with the message RRC setup complete, specified in TS 38.331 v17.0.0, which may include an IE indicating the RRC connection is related to a mobile IAB-node.

At step 811, the IAB-MT part of the mobile IAB-node 810 regularly performs measurement on signals received at the IAB-MT from the serving cell and one or more target cells, such as the Signal Synchronization Block (SSB) transmitted in the serving cell and in the target cells. The target cells may be neighbouring cells to the serving or source cell (i.e., the current serving cell).

Once the IAB-MT discovers at least one SSB that meets predefined criteria (for instance a received power that exceeds a predefined threshold), the mobile IAB-node 810 may send a measurement report through the RRC message 831 to the source parent IAB-node, and this measurement report is forwarded to the source donor CU 803 through a backhaul message (BAP data PDU) 832. The measurements in step 811 provide radio link quality information for different cells in the vicinity of the mobile IAB-node 810. The identity of each cell is included in the measurement report to allow the source donor CU 803 to identify the target CU associated with the cell.

Based on the received measurement report, the source donor-CU 803 may detect that the mobile IAB-node 810 receives radio signals in a cell controlled by the target parent IAB-node 809 with a better quality than in the current serving cell controlled by the source parent IAB-node 808. As in this example the target parent IAB-node belongs to another IAB topology, the source donor CU 803 may decide at step 812 the partial migration of the mobile IAB-node 810.

To trigger the partial migration, the source donor CU 803, sends a handover request message 833 to the selected target donor CU 807 including the necessary information related to the device to hand over. The handover request message may be the HANDOVER REQUEST message specified in the 3GPP document TS 38.423 (v17.0.0) section 9.1.1.1, which includes the Information Element (IE) IAB Node Indication, a Boolean indicating whether the handover concerns an IAB-node. In case the IAB Node Indication, is set to true, the target donor CU receiving this IE can understand that the handover request is related to a partial migration of an IAB-node.

According to one embodiment of the invention, a new IE Mobile IAB Node Indication is added. This IE may be a Boolean (i.e., a variable which can take one of two values) to indicate whether the partial migration concerns a mobile IAB-node. This information can be used by the target donor CU 807 in the admission control step 813 to decide whether the request is accepted or not. The decision may be based on criteria such as the current load of the target donor CU (load of the processing resources), and/or the current load on the backhaul links in the target IAB topology. The target donor CU 807 may reject the partial migration considering it may create situations with overload. When the handover request concerns the partial migration of a mobile IAB-node, the target donor CU may always accept such request, as it may be the only possible option for the mobile IAB-node to continue serving its UEs, taking also into account that the presence of the mobile IAB-node may be temporary as it may cross, and not remain in the IAB topology controlled by the target donor CU. At least, the target donor CU may give priority to a request for partial migration of a mobile IAB-node, or it may consider revocation of such request only in exceptional circumstances (e.g., where service would be severely limited or impossible given current load).

The IE Mobile IAB Node Indication may include additional information, for instance the number of UEs served by the migrating mobile IAB-node, and/or quality of service (QoS) parameters (e.g., a priority level, a required latency or packet delay budget, a packet error rate, a maximum data burst volume) related to the traffic currently handled by the mobile IAB-node. Several QoS parameters may be gathered and indicated by a QoS level or value. Such information would help the target donor CU to anticipate some traffic migration from the source IAB topology to the target IAB topology which may assist the decision process to accept or reject the migration request or apportion resources accordingly prior to/following acceptance.

Once the target donor CU 807 has accepted the request, the procedure is completed at step 814, as specified in TS 38.401 v17.0.0 section 8.17.3.1. Finally, the mobile IAB-node 810 is partially migrated (with the RRC connection) in the IAB topology of the target donor CU 807. Thus, a measurement report from the MT part of the mobile IAB-node 810 is now transmitted through the RRC message 835 to the target parent IAB-node 809, and then through the backhaul message 836 to the target donor CU 807.

FIG. 9 is a simplified flowchart 900 illustrating an example of steps to perform the dual-connectivity of a mobile IAB-node according to embodiments of the invention. This figure shows a UE 901 like the UE 580, a source donor CU 903 like the donor CU 401, a target donor CU 907 like the donor CU 402, the core network (5GC) 902 like the core network 110. This figure also shows a mobile IAB-node 910 like the IAB-node 470, a source parent IAB-node 908, like the IAB-node 430, belonging to the IAB topology controlled by the source donor CU 903, a target parent IAB-node 909, like the IAB-node 450, belonging to the IAB topology controlled by the target donor CU 907.

At the beginning of the flowchart, the mobile IAB-node 810 fully belongs to the source IAB topology controlled by the source donor CU 903. It is connected through a cell controlled by the source parent IAB-node 908. The UE 901 is served by the mobile IAB-node 910. The user data in the downstream direction are provided by the 5GC 902 to the source donor CU 903 through the bearer 920, then they are transmitted to the mobile IAB-node 910 via the source parent IAB-node 908 through the backhaul bearer 921 in the source IAB topology, and finally to the UE 901 through the data radio bearer 923. User data in the upstream direction (not represented in the figure) are transmitted through similar bearers in the opposite direction.

The source donor CU 903 has the information that the IAB-node 910 is a mobile IAB-node, for instance, because it was informed at the RRC connection of the IAB-node 910, with the message RRC setup complete, specified in TS 38.331 v17.0.0, which may include an IE indicating the RRC connection is related to a mobile IAB-node.

At step 911, the IAB-MT part of the mobile IAB-node 910 regularly performs measurement on signals received at the IAB-MT from the serving cell and one or more target cells, such as the Signal Synchronization Block (SSB) transmitted in the serving cell and in the target cells. The target cells may be neighbouring cells to the serving or source cell (i.e., the current serving cell).

Once the IAB-MT discovers at least one SSB that meets predefined criteria (for instance a received power that exceeds a predefined threshold), the mobile IAB-node 910 may send a measurement report through the RRC message 931 to the source parent IAB-node, and this measurement report is forwarded through a backhaul message (BAP data PDU) 932 to the source donor CU 903. The measurements in step 911 provide radio link quality information for different cells in the vicinity of the mobile IAB-node 910. The identity of each cell is included in the measurement report to allow the source donor CU 903 to identify the target CU associated with the cell.

Based on the received measurement report, the source donor-CU 903 may detect that the mobile IAB-node 910 receives radio signals in a cell controlled by the target parent IAB-node 909 with a sufficient quality to connect to a second parent IAB-node. As in this example the target parent IAB-node belongs to another IAB topology, the source donor CU 903 may decide at step 912 the dual-connectivity (DC) of the mobile IAB-node 810.

To trigger the dual-connectivity procedure, the source donor CU 903 sends a node addition request message 933 to the selected target donor CU 907 including the necessary information related to the device to connect to. The node addition request message may be the S-NODE ADDITION REQUEST message specified in the 3GPP document TS 38.423 (v17.0.0) section 9.1.2.1, which includes the Information Element (IE) IAB Node Indication, a Boolean indicating whether the request for dual-connectivity concerns an IAB-node. In case the IAB Node Indication, is set to true, the target donor CU receiving this IE can understand that the request is related to an IAB-node.

According to one embodiment of the invention, a new IE Mobile IAB Node Indication is added. This IE may be a Boolean to indicate whether the request concerns a mobile IAB-node. This information can be used by the target donor CU 907 in the admission control step 913 to decide whether the request for dual-connectivity is accepted or not. The decision may be based according to criteria like the current load of the target donor CU (load of the processing resources), or the current load on the backhaul links in the target IAB topology. The target donor CU 907 may reject the request for dual-connectivity considering it may create situations with overload. When the request concerns a mobile IAB-node, the target donor CU may always accept such request as it should be a first phase before the full migration of the mobile IAB-node, taking also into account that the presence of the mobile IAB-node may be temporary as it may just cross, and not remain in the IAB topology controlled by the target donor CU. At least, the target donor CU may give priority to a request for dual-connectivity related to a mobile IAB-node, or it may consider as exceptional the revocation of such request.

According to another embodiment of the invention, the IE Mobile IAB Node Indication may include additional information, for instance the number of UEs served by the migrating mobile IAB-node, and/or quality of service (QoS) parameters (e.g., required latency) related to the traffic currently handled by the mobile IAB-node. Such information would help the target donor CU to anticipate some traffic migration from the source IAB topology to the target IAB topology.

Once the target donor CU 907 has accepted the request, the procedure is completed at step 914, as specified in TS 38.401 v17.0.0 section 8.17.2.1. Finally, the mobile IAB-node 910 is dual connected with two parent IAB nodes: the source parent IAB-node 908 and the target parent IAB-node 909 belonging to two different IAB topologies. Thus, the mobile IAB-node is a boundary node.

FIG. 10 is a simplified flowchart 1000 illustrating an example of steps to perform the Radio Link Failure (RLF) recovery of a mobile IAB-node according to embodiments of the invention. This figure shows a UE 1001 like the UE 480, a source donor CU 1003 like the donor CU 401, a target donor CU 1007 like the donor CU 402, the core network (5GC) 1002 like the core network 110. This figure also shows a mobile IAB-node 1010 like the IAB-node 470, a source parent IAB-node 1008, like the IAB-node 430, belonging to the IAB topology controlled by the source donor CU 1003, a target parent IAB-node 1009, like the IAB-node 450, belonging to the IAB topology controlled by the target donor CU 1007.

At the beginning of the flowchart, the mobile IAB-node 1010 fully belongs to the source IAB topology controlled by the source donor CU 1003. It is connected through a cell controlled by the source parent IAB-node 1008. The UE 1001 is served by the mobile IAB-node 1010. The user data in the downstream direction are provided by the 5GC 1002 to the source donor CU 1003 through the bearer 1020, then they are transmitted to the mobile IAB-node 1010 via the source parent IAB-node 1008 through the backhaul bearer 1021 in the source IAB topology, and finally to the UE 1001 through the data radio bearer 1023. User data in the upstream direction (not represented in the figure) are transmitted through similar bearers in the opposite direction.

The source donor CU 1003 has the information that the IAB-node 1010 is a mobile IAB-node, for instance, because it was informed at the RRC connection of the IAB-node 1010, with the message RRC setup complete, specified in TS 38.331 v17.0.0, which may include an IE indicating the RRC connection is related to a mobile IAB-node.

At step 1011, the IAB-MT part of the mobile IAB-node 1010 regularly performs measurement on signals received at the IAB-MT from the serving cell and one or more target cells, such as the Signal Synchronization Block (SSB) transmitted in the serving cell and in the target cells. The target cells may be neighbouring cells to the serving or source cell (i.e., the current serving cell).

It may happen that the SSB signal in the serving cell meets predefined criteria (for instance a received power that is below a predefined threshold) during a sufficient time to declare a RLF for the link between the mobile IAB node 1010 and its source parent IAB-node 1008. Besides, the mobile IAB-node 1010 may have detected a SSB signal that meets predefined criteria (for instance a received power that is above a predefined threshold) sufficient to attempt a new connection in the corresponding target cell. In that case, the mobile IAB-node 1010 triggers a reestablishment request procedure 1032 as described in TS 38.401 v17.0.0 section 8.17.4. It consists in performing a random-access procedure to obtain uplink resources, and then to transmit a RRC Reestablishment Request message in the target cell. This RRC message is received by the target parent IAB-node (1009 in the example of the FIG. 10), and the message is relayed to the target IAB-donor CU (1007 in the example of the FIG. 10).

Upon reception of a RRC reconnection request including information to identify the source donor CU 1003 of the requesting device, the target donor CU 1007 sends a context request message 1033 to the source donor CU (1003 in the example of the FIG. 10) to retrieve the context of the requesting device. In response, the source donor CU 1003 sends to the target donor CU 1007 a context response message 1034 including the requested information. The context request message may be the RETRIEVE UE CONTEXT REQUEST message specified in the 3GPP document TS 38.423 (v17.0.0) section 9.1.1.8. The context response message may be the RETRIEVE UE CONTEXT RESPONSE message specified in the 3GPP document TS 38.423 (v17.0.0) section 9.1.1.9, which includes the Information Element (IE) IAB Node Indication, a Boolean indicating whether the device concerns an IAB-node. In case the IAB Node Indication, is set to true, the target donor CU receiving this IE can understand that the RRC reconnection request is related to an IAB-node. According to one embodiment of the invention, a new IE Mobile IAB Node Indication is added. This IE may be a Boolean to indicate whether the device is a mobile IAB-node. This information can be used by the target donor CU 1007 in the admission control step 1013 to decide whether the request is accepted or not. The decision may be based according to criteria like the current load of the target donor CU (load of the processing resources), or the current load on the backhaul links in the target IAB topology. The target donor CU 1007 may reject the reconnection request considering it may create situations with overload. When the reconnection request concerns a mobile IAB-node, the target donor CU may always accept such request as it may be the only possible option for the mobile IAB-node to continue serving its UEs, taking also into account that the presence of the mobile IAB-node may be temporary as it may cross, and not remain in the IAB topology controlled by the target donor CU. At least, the target donor CU may give priority to a request from a mobile IAB-node, or it may consider as exceptional the revocation of such request.

In another embodiment, the IE Mobile IAB Node Indication may include additional information, for instance the number of UEs served by the requesting mobile IAB-node, and/or quality of service (QOS) parameters (e.g., required latency) related to the traffic currently handled by the mobile IAB-node. Such information would help the target donor CU to anticipate some traffic migration from the source IAB topology to the target IAB topology.

Once the target donor CU 1007 has accepted the request, the procedure is completed at step 1014, as specified in TS 38.401 v17.0.0 section 8.17.4. The target donor CU 1007 may send to the source donor CU 1003, an indication of the reconnection of the mobile IAB-node. This message may be the UE CONTEXT RELEASE message specified in TS 38.423 V17.0.0. Finally, the mobile IAB-node 810 is partially migrated (with the RRC connection) in the IAB topology of the target donor CU 1007. Thus, a measurement report from the MT part of the mobile IAB-node 1010 is now transmitted through the RRC message 1035 to the target parent IAB-node 1009, and then through the backhaul message 1036 to the target donor CU 1007.

FIG. 11 is a flowchart 1100 illustrating an example of the procedure to perform traffic migration from a first IAB topology to a second IAB topology according to embodiments of the invention.

This figure shows two donor CUs (donor-CUa) 1101 and (donor-CUb) 1102 like the donor CU 401 or 402.

After the completion of the procedures described in the FIGS. 8, 9 and 10, the source donor CU may request the migration of traffic related to the mobile IAB-node toward the target IAB topology. In this case, the source donor CU, which then corresponds to the donor CUa 1101 in the FIG. 11, sends the message IAB transport request 1111 to the target donor CU, which then corresponds to the donor CUb 1102 in the FIG. 11. The message 1111 contains the necessary information for the target donor CU to understand the characteristics of the traffic to be migrated (e.g., maximum throughput, downlink or uplink, QoS level.) . The target donor CU can analyze the received information and accept the whole traffic migration. It may also partially or fully revoke the traffic migration, for instance because of some potential load issues. The response of the target donor CU is sent with the message IAB transport response 1112.

The procedure described in FIG. 11 may correspond to the procedure IAB Transport Migration Management specified in TS 38.401 v17.0.0 section 8.5.2. Thus, the message IAB transport request 1111 may correspond to the message IAB TRANSPORT MIGRATION MANAGEMENT REQUEST from the F1-terminating donor (i.e., the source donor CU) to the non-F1-terminating donor (i.e., the target donor CU). Besides, the message IAB transport response 1112 may correspond to the message IAB TRANSPORT MIGRATION MANAGEMENT RESPONSE from the non-F1-terminating donor (i.e., the target donor CU) to the F1-terminating donor (i.e., the source donor CU).

In case of traffic migration related to a mobile IAB node, the target IAB donor CU should always accept such request as it may be the only possible option for the mobile IAB-node to continue serving its UEs, taking also into account that the presence of the mobile IAB-node may be temporary as it may cross and not remain in the IAB topology controlled by the target donor CU. At least, the target donor CU may give priority to a traffic migration request for traffic related to a mobile IAB-node, or it may consider as exceptional the revocation of such request.

Thus, according to one embodiment of the invention, a new IE Mobile IAB Node Indication is added in the message IAB transport request 1111. This IE may be a Boolean to indicate whether the device associated to the traffic to migrate is a mobile IAB-node. This information can be used by the target donor CU to decide whether the traffic migration is accepted or not.

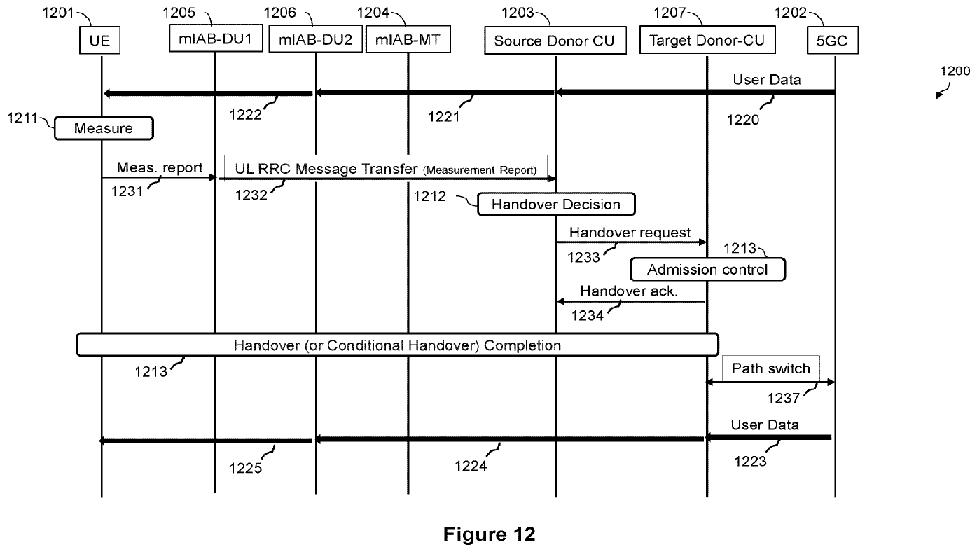

FIG. 12 is a simplified flowchart 1200 illustrating an example of steps to perform the handover of UEs served by a mobile IAB-node fully migrating from a source IAB topology to a target IAB topology according to embodiments of the invention.

This figure shows a UE 1201 like the UE 580, a source donor CU 1203 like the donor CU 501, a target donor CU 1207 like the donor CU 502, the core network (5GC) 1202 like the core network 110. This figure also shows a mobile IAB-node like the IAB-node 570 and 601 composed of an IAB-MT part or unit mIAB-MT 1204, an IAB-DU1 part or unit mIAB-DU1 1205, and an IAB-DU2 part or unit mIAB-DU2 1206. mIAB-DU1 and mIAB-DU2 are two logical DU entities that share the same hardware for the BAP, RLC, and MAC layers. In one embodiment, they share the same physical layer (i.e., the same hardware resources), while in another embodiment they rely on separated physical layers.

At the beginning of the flowchart, the mobile IAB-node is partially migrated to the target IAB topology controlled by the target donor CU 1207, and both logical DUs of the mobile IAB-node are active. mIAB-DU1 1205 provides F1 termination to the source donor CU 1203, while mIAB-DU2 1206 provides F1 termination to the target donor CU 1207. The UE 1201 is served by the mobile IAB-node through a cell controlled by the mIAB-DU1 1205. The user data in the downstream direction are provided by the 5GC 1202 to the source donor CU 1203 through the bearer 1220, then they are transmitted to the logical DU mIAB-DU1 1205 of the mobile IAB-node through the backhaul bearer 1221 in the source IAB topology, and finally to the UE 1201 through the data radio bearer 1222. User data in the upstream direction (not represented in the figure) are transmitted through similar bearers in the opposite direction.

At step 1211, the UE 1201 periodically performs measurement on signals received from the serving cell and one or more target cells, such as the Signal Synchronization Block (SSB) transmitted in the serving cell and in the target cells. The target cells may be neighbouring cells to the serving or source cell (i.e., the current serving cell).

Once the UE 1201 discovers at least one SSB that meets predefined criteria (for instance a received power that exceeds a predefined threshold), the UE 1210 may send a measurement report through the RRC message 1231 to the mobile IAB node, and this measurement report is forwarded through a backhaul message (BAP data PDU) 1232 to the source donor CU 1203. The measurements in step 1211 provide radio link quality information for different cells in the vicinity of the UE 1201. The identity of each cell is included in the measurement report to allow the source donor CU 1203 to identify the target CU associated with the cell.

Based on the received measurement report, the source donor-CU 1203 may detect that the UE 1201 receives radio signals in a cell controlled by the mIAB-DU2 1206. Then at step 1212, the source donor CU 1203 can decide the handover of UE 1201 toward the target donor-CU 1207 through the cell controlled by mIAB-DU2 1206.

To trigger the UE handover, the source donor CU 1203, sends a handover request message 1233 to the target donor CU 1207 including the necessary information related to the UE to hand over. The handover request message may be the HANDOVER REQUEST message specified in the 3GPP document TS 38.423 (v17.0.0) section 9.1.1.1.

According to one embodiment of the invention, a new IE Group Mobility Indication is added in the message 1233. This IE may be a Boolean to indicate whether the UE handover concerns a UE served by a migrating mobile IAB-node, meaning the UE is part of the group of devices moving with the mobile IAB-node. It may be the case of on-board UEs inside a vehicle with the mobile IAB-node mounted on top the vehicle. This Group Mobility Indication IE can be used by the target donor CU 1207 in the admission control step 1213 to decide whether the handover request is accepted or not. The decision may be based according to criteria like the current load of the target donor CU (load of the processing resources), or the current load on the backhaul links in the target IAB topology. The target donor CU 1207 may reject the UE handover considering it may create situations with overload. When the handover request concerns a UE belonging to the group mobility of a migrating mobile IAB-node, the target donor CU should always accept such request as part of the full migration of the mobile IAB-node serving the UE. Otherwise, the UE may lose the connection with the source donor CU 1203 when the mIAB-DU1 1205 is deactivated, and it may cause service interruption at this UE.

Once the target donor CU 1207 has accepted the handover request, the target donor CU 1207 sends a handover acknowledgement message 1234 to the source donor CU 1203. The UE handover is completed at step 1214, as specified in TS 38.300 v17.0.0 section 9.2.3.2.

The handover procedure may be a conditional handover where the decision to switch to the new serving cell is let to the UE according to some conditions provided by the source donor CU 1207.

Finally, the UE 1201 is served by a cell controlled by the mIAB-DU2 1206, and thus it is connected to the target donor CU 1207. The target donor CU 1207 may perform a path switch procedure 1237 toward the core network 1202 to request the delivery of the user data dedicated to the UE 1201. Then, the user data in the downstream direction are transmitted by the core network 1202 to the target donor CU 1207 through the bearer 1223, then they are transmitted to the logical DU mIAB-DU2 1206 of the mobile IAB-node through the backhaul bearer 1224 in the target IAB topology, and finally to the UE 1201 through the data radio bearer 1226. User data in the upstream direction (not represented in the figure) are transmitted through similar bearers in the opposite direction. Also, the traffic related to the UE 1201 that was previously migrated by the IAB-donor CU 1203 toward the IAB topology controlled by the target donor CU 1207, may be released as it is no more handled by the source donor CU 1203. To perform this release, the source donor CU 1203 may apply the IAB transport migration management procedure specified in TS 38.423 v17.0.0 section 8.5.2, or the target donor CU 1207 may apply the IAB transport migration modification procedure specified in TS 38.423 v17.0.0 section 8.5.3.

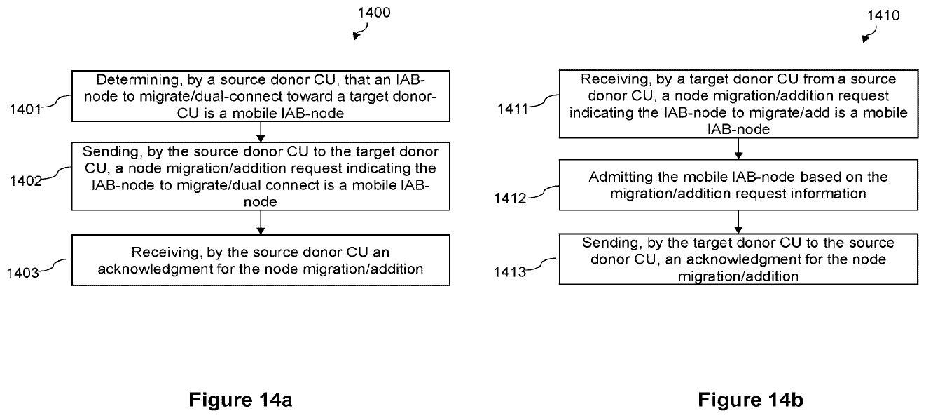

FIGS. 14 to 17 show simplified methods performed by a source donor CU (FIGS. 14a, 15a, 16a and 17a) and a target donor CU (FIGS. 14b, 15b, 16b and 17b) relating to requesting resources from a source IAB topology to a target IAB topology in four different scenarios. The term ‘requesting resources’ can refer to requesting partial or full migration, or establishing dual connectivity. In some cases, full migration may occur following partial or dual connectivity.

The method steps include the exchange of messages between the source donor CU and the target donor CU; each example includes the feature of indicating that the process relates to a mobile IAB-node. As previously discussed, this allows prioritisation of the traffic/node migration. Such a prioritisation may be necessary as the UEs served by the mobile IAB-node may not have a viable alternative; or prioritisation may be acceptable as the increased load may only be transitory as the mobile IAB-node is likely to migrate to a neighbouring cell.

FIG. 14a illustrates, using a flowchart 1400, an example method for managing at a source donor CU the indication that partial migration or dual-connectivity setup is related to a mobile IAB-node.

In case of partial migration of an IAB node, the steps are the followings:

At step 1401, a source donor CU, like an IAB donor CU 401, determines that an IAB-node to migrate toward a target donor CU is a mobile IAB-node.

At step 1402, the source donor CU sends to the target donor CU, a node migration request indicating the IAB-node to migrate is a mobile IAB-node.

At step 1403, the source donor CU receives from the target donor CU an acknowledgment for the node migration.

In case of a dual-connectivity setup of an IAB node, the steps are essentially the same, but are modified in the following way:

At step 1401, a source donor CU, like an IAB donor CU 401, determines that an IAB-node to dual-connect toward a target donor CU is a mobile IAB-node.

At step 1402, the source donor CU sends to the target donor CU, a node addition request indicating the IAB-node to dual-connect is a mobile IAB-node.

At step 1403, the source donor CU receives from the target donor CU an acknowledgment for the node addition.

FIG. 14b illustrates, using a flowchart 1410, a corresponding method to FIG. 14a performed at a target donor CU to undertake partial migration or dual-connectivity setup related to a mobile IAB-node.

In case of a partial migration of an IAB node, the steps are the followings:

At step 1411, a target donor CU, like an IAB donor CU 402, receives from a source donor CU a node addition request indicating the IAB-node to migrate is a mobile IAB-node.

At step 1412, the target donor CU admits the mobile IAB-node based on the migration request information that indicates it is related to a mobile IAB-node. The admission is related to the RRC connection of the mobile IAB-node to the target donor CU.

At step 1413, the target donor CU sends to the source donor CU an acknowledgment for the node migration.

In case of dual-connectivity setup of an IAB node, the steps are modified as follows:

At step 1411, a target donor CU, like an IAB donor CU 402, receives from a source donor CU a node addition request indicating the IAB-node to dual-connect is a mobile IAB-node.

At step 1412, the target donor CU admits the mobile IAB-node based on the addition request information that indicates it is related to a mobile IAB-node. The admission is related to the RRC connection of the mobile IAB-node to the target donor CU.

At step 1413, the target donor CU sends to the source donor CU an acknowledgment for the node addition.

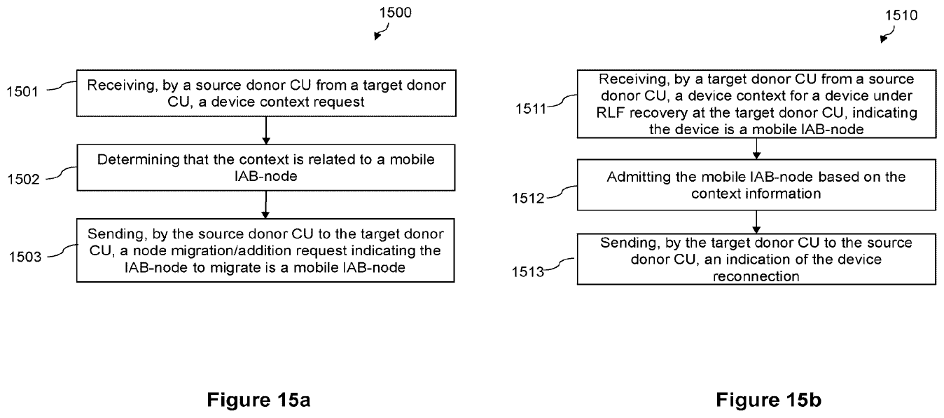

FIG. 15a illustrates, using a flowchart 1500, an example method for managing at a source donor CU the indication that a Radio Link Failure (RLF) recovery is related to a mobile IAB-node.

At step 1501, a source donor CU, like an IAB donor CU 401, receives from a target donor CU a request to retrieve the context of a device.

At step 1502, the source donor CU determines that the context to provide is related to a mobile IAB-node.

At step 1503, the source donor CU sends to the target donor CU, a response containing the context of the device and indicating that the device is a mobile IAB-node.

FIG. 15b illustrates, using a flowchart 1510, a corresponding method to FIG. 15a for managing at a target donor CU the indication that a Radio Link Failure (RLF) recovery is related to a mobile IAB-node.

At step 1511, a target donor CU, like an IAB donor CU 402, receives from a source donor CU a device context for a device under RLF recovery at the target donor CU, indicating that the device is a mobile IAB-node.

At step 1512, the target donor CU admits the mobile IAB-node based on the context information indicating the device under RLF recovery is related to a mobile IAB-node. The admission is related to the RRC connection of the mobile IAB-node to the target donor CU.

At step 1513, the target donor CU sends to the source donor CU, an indication of the reconnection of the mobile IAB-node.

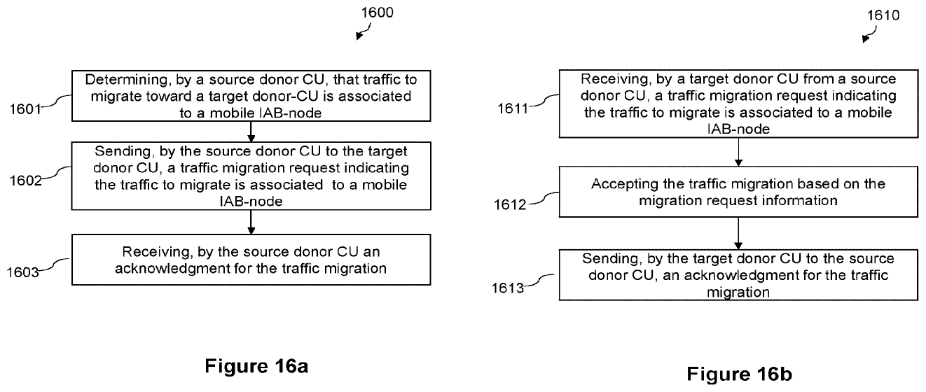

FIG. 16a illustrates, using a flowchart 1600, an example method for managing at a source donor CU the indication that a traffic migration is related to a mobile IAB-node.

At step 1601, a source donor CU, like an IAB donor CU 401, determines that traffic to migrate toward a target donor-CU is associated to a mobile IAB-node.

At step 1602, the source donor CU sends to the target donor CU, a traffic migration request indicating the traffic to migrate is associated to a mobile IAB-node.

At step 1603, the source donor CU receives from the target donor CU, an acknowledgment for the traffic migration.

FIG. 16b illustrates, using a flowchart 1610, a corresponding method to FIG. 16a for managing at a target donor CU the indication that a traffic migration is related to a mobile IAB-node.

At step 1611, a target donor CU, like an IAB donor CU 402, receives from a source donor CU a traffic migration request indicating the traffic to migrate is associated to a mobile IAB-node.

At step 1612, the target donor CU accepts the traffic migration based on the traffic migration request that indicates the traffic to migrate is associated to a mobile IAB-node.

At step 1613, the target donor CU sends to the source donor CU, an acknowledgment for the traffic migration.

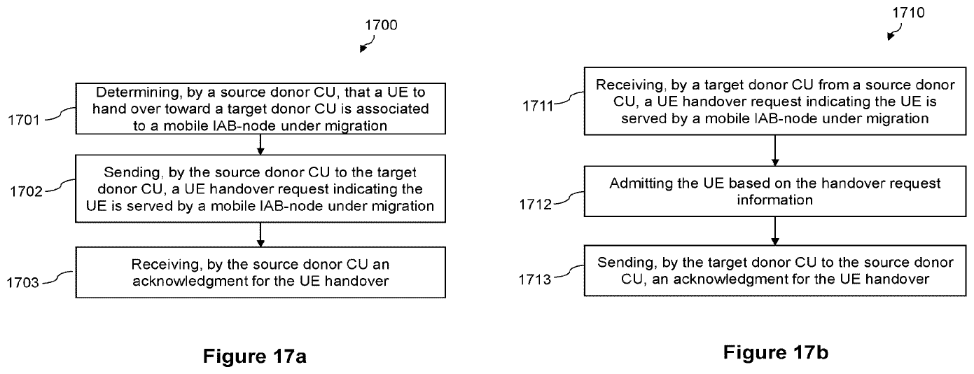

FIG. 17a illustrates, using a flowchart 1700, an example method for managing at a source donor CU the indication that a UE handover is associated to a mobile IAB-node.

At step 1701, a source donor CU, like an IAB donor CU 401, determines that a UE to hand over toward a target donor CU is associated to a mobile IAB-node under migration.

At step 1702, the source donor CU sends to the target donor CU, a UE handover request indicating the UE is served by a mobile IAB-node under migration. The message may indicate that the UE belongs to the group mobility of the mobile IAB-node under migration.

At step 1703, the source donor CU receives from the target donor CU, an acknowledgment for the UE handover.

FIG. 17b illustrates, using a flowchart 1710, a corresponding method to FIG. 17a for managing at a target donor CU the indication that a UE handover is associated to a mobile IAB-node.

At step 1711, a target donor CU, like an IAB donor CU 402, receives from a source donor CU a UE handover request indicating the UE is served by a mobile IAB-node under migration.

At step 1712, the target donor CU admits the UE based on the handover request information that indicates the UE is served by a mobile IAB-node under migration.

At step 1713, the target donor CU sends to the source donor CU, an acknowledgment for the UE handover.

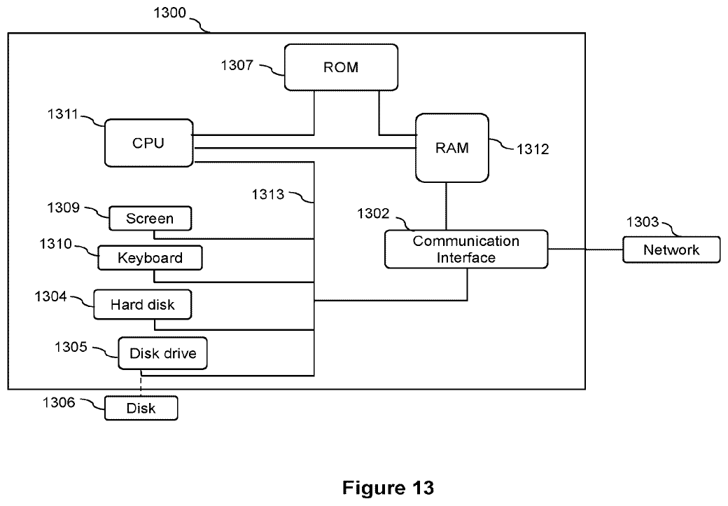

FIG. 13 shows a schematic representation of a communication device or station, in accordance with one or more example embodiments of the present disclosure.

The communication device 1300 may preferably be a device such as a micro-computer, a workstation or a light portable device. The communication device 1300 comprises a communication bus 1313 to which there are preferably connected:
a central processing unit 1311, such as a microprocessor, denoted CPU;
a read only memory 1307, denoted ROM, for storing computer programs for implementing the invention;
a random-access memory 1312, denoted RAM, for storing the executable code of methods according to embodiments of the invention as well as the registers adapted to record variables and parameters necessary for implementing methods according to embodiments of the invention; and
at least one communication interface 1302 connected to the radio communication network 100 over which digital data packets or frames or control frames are transmitted, for example a wireless communication network according to the release 16 for 5G NR. The frames are written from a FIFO sending memory in RAM 1312 to the network interface for transmission or are read from the network interface for reception and writing into a FIFO receiving memory in RAM 1312 under the control of a software application running in the CPU 1311.

Optionally, the communication device 1300 may also include the following components:
a data storage means 1304 such as a hard disk, for storing computer programs for implementing methods according to one or more embodiments of the invention;
a disk drive 1305 for a disk 1306, the disk drive being adapted to read data from the disk 1106 or to write data onto said disk;
a screen 1309 for displaying decoded data and/or serving as a graphical interface with the user, by means of a keyboard 1310 or any other pointing means.

Preferably the communication bus provides communication and interoperability between the various elements included in the communication device 1300 or connected to it. The representation of the bus is not limiting and in particular, the central processing unit is operable to communicate instructions to any element of the communication device 1300 directly or by means of another element of the communication device 1300.

The disk 1306 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1307, on the hard disk 1304 or on a removable digital medium such as for example a disk 1106 as described previously. According to an optional variant, the executable code of the programs can be received by means of the communication network 1303, via the interface 1302, in order to be stored in one of the storage means of the communication device 1300, such as the hard disk 1304, before being executed.

The central processing unit 1311 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1304 or in the read only memory 1307, are transferred into the random-access memory 1312, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Reference numerals appearing in the claims are by way of illustration only and shall have no limiting effect on the scope of the claims.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

1. A method for use in a process for requesting resources by a source Integrated Access and Backhaul (IAB) topology from a target IAB topology of a communication system, each of the source IAB topology and the target IAB topology comprising a set of IAB nodes and a donor Central Unit (CU), the method at the source donor-CU of the source IAB topology comprising:
transmitting a message to the target donor-CU of the target IAB topology relating to the request of resources associated with an IAB-node of the source IAB topology;
wherein the message comprises an indication identifying the IAB-node of the source IAB topology as a mobile IAB-node.

2. The method according to claim 1, wherein the indication identifying the IAB-node as a mobile IAB-node comprises a Boolean.

3. The method according to claim 1, wherein the message comprises information regarding the number of user equipment served by the mobile IAB-node.

4. The method according to claim 1, wherein the message comprises a quality-of-service level.

5. The method according to claim 4, wherein the quality-of-service level indicates at least one quality-of-service parameter among: a priority level, a required packet delay budget, a required packet error rate, and a maximum data burst level, and/or the quality-of-service level comprises a combination of several quality-of-service parameters.

6. (canceled)

7. The method according to claim 1, wherein the process for requesting resources comprises an IAB Inter-CU topological redundancy procedure.

8. The method according to claim 1, wherein the process for requesting resources comprises an IAB Inter-CU Backhaul radio link failure recovery, optionally a Reestablishment request procedure.

9. (canceled)

10. The method according to claim 1, wherein the process for requesting resources comprises an inter-CU topology adaptation procedure.

11. The method according to claim 1, wherein the process for requesting resources comprises a full migration of the IAB-node, optionally the IAB-node includes a Distributed Unit (DU) part, and wherein the full migration comprises the migration of the DU part of the IAB-node from the source donor-CU to the target donor-CU.

12. (canceled)

13. The method according to claim 11, wherein the process for requesting resources comprises a user equipment Handover (HO) procedure, or a user equipment Conditional Handover (CHO) procedure, optionally the indication identifying the IAB-node as a mobile IAB-node comprises an indication that the UE undergoing handover is served by the mobile IAB-node.

14. (canceled)

15. (canceled)

16. The method according to claim 1, further comprising, prior to the step of transmitting a message, determining that the IAB-node of the source IAB topology is a mobile IAB-node.

17. The method of claim 16, wherein determining that the IAB-node is a mobile IAB-node comprises obtaining a user equipment context.

18. The method of claim 17, further comprising receiving a request for a user equipment context from the target donor-CU.

19. A method for use in a process for requesting resources by a source Integrated Access and Backhaul (IAB) topology from a target IAB topology of a communication system, each of the source IAB topology and the target IAB topology comprising a set of IAB nodes and a donor Central Unit (CU), the method at the target donor-CU of the target IAB topology comprising:
receiving a message relating to the request of resources associated with an IAB node of the source IAB topology;
obtaining from the message, an indication identifying that the related IAB-node of the source IAB topology is a mobile IAB-node or not; and
determining whether to accept or reject the request in dependence on the indication.

20. The method of claim 19, wherein the method comprises prioritising the request in dependence on the indication.

21. The method of claim 20, wherein the method comprises always accepting the request in dependence on the indication.

22. The method according to claim 19, wherein determining whether to accept or reject the request is further in dependence on a current load of the target IAB topology, or on a current load on backhaul links in the target IAB topology.

23. (canceled)

24. The method according to claim 1, wherein requesting resources relates to a request to establish a dual connectivity of the IAB-node with the source donor CU and the target donor CU, or a request for a partial migration of the IAB-node of the source IAB topology, optionally the IAB-node includes a Mobile Termination (MT) part, and wherein the partial migration comprises the migration of the MT part of the IAB-node from the source donor-CU to the target donor-CU.

25. (canceled)

26. (canceled)

27. A source donor Central Unit, CU, for managing a process for requesting resources by a source Integrated Access and Backhaul (IAB) topology from a target IAB topology of a communication system, the source donor-CU comprising:
a transmitter that transmits a message to a target donor CU of the target IAB topology relating to the request of resources associated with an IAB-node of the source IAB topology;
wherein the message comprises an indication identifying the IAB-node of the source IAB topology as a mobile IAB-node.

28. (canceled)

29. (canceled)

30. (canceled)

31. A non-transitory computer readable medium comprising instructions which, when executed by a computer, cause the computer to carry out the method according to claim 1.

32. (canceled)
